(19) United States
(12) Patent Application Publication
(10) Pub. No.: US 2024/0373836 A1
(43) Pub. Date: Nov. 14, 2024

(54) Agriculture Detection Protection System (ADPS)

(71) Applicant: David Ridl, Gilbert, AZ (US)

(72) Inventor: David Ridl, Rapid City, SD (US)

(73) Assignee: David Ridl, Gilbert, AZ (US)

(21) Appl. No.: 18/630,582

(22) Filed: Apr. 9, 2024

Related U.S. Application Data
(63) Continuation-in-part of application No. 63/495,100, filed on Apr. 9, 2023.

(51) Int. Cl. A01M 31/00; A01M 7/00; A01M 29/10; B64D 1/18; B64U 101/40; B64U 101/45

(52) U.S. Cl. CPC A01M 31/002; A01M 7/0089; B64D 1/18; A01M 29/10; B64U 2101/40; B64U 2101/45

(57) ABSTRACT

The Agriculture Detection Protection System (ADPS) emerges as a revolutionary guardian for crop and livestock protection. Integrating LIDAR, radar, cameras, and sound systems with advanced drones, the ADPS not only surveils but intelligently interacts with its environment, using AI to analyze crop health and deploy various deterrents against wildlife threats. These drones, equipped with dispensers for precise agricultural interventions and visual deterrents, adapt to ever-changing field conditions. By combining real-time monitoring with eco-friendly practices, the ADPS offers a comprehensive, adaptive solution to safeguard agricultural fields, striking a delicate balance between technological innovation and environmental stewardship.

### INCORPORATION BY REFERENCE

This non-provisional patent application expressly incorporates by reference the entire contents and substance of the previously filed provisional patent application titled “ADPS=Agriculture Detection Protection System”, which is assigned U.S. Provisional Application No. 63/495,100. The provisional application, filed by David Steve Ridl on Apr. 9, 2023, at 11:00:29 AM ET, under Utility-Provisional Application under 35 USC 111 (b) with Confirmation No. 9103 and Patent Center No. 61885901, establishes foundational aspects, preliminary data, and initial concepts pertinent to the Agriculture Detection Protection System (ADPS) that are relevant to the disclosures in this current application.

### BACKGROUND OF THE INVENTION

The concept of the Agriculture Detection Protection System (ADPS) was born out of an innovative project that triumphed in a technology competition in 2016 at the University of Arizona, Yuma, AZ. Recognized for its advanced technological approach to agricultural challenges, the ADPS project was distinguished for its potential to revolutionize field surveillance, crop health management, and wildlife mitigation in agriculture.

Following this initial success, the journey to bring the ADPS to fruition involved a dedicated search for the right partnerships and resources. The primary goal was to develop a system that not only addressed the pressing needs of modern agriculture but also integrated the latest advancements in technology. This phase was marked by rigorous research and collaboration with experts in various fields, including agricultural science, technology, and environmental sustainability.

Transitioning from a promising concept to a tangible solution, the ADPS project entered its Beta development phase. This phase has been critical in refining the system's design and functionality, ensuring that each component, from LIDAR and radar sensors to multifunctional drones and AI algorithms, works in synergy to deliver an effective and efficient agricultural management solution.

Currently, the project is on a trajectory to unveil its beta trailer by the first quarter of 2025. This milestone will mark a significant step forward, bringing the ADPS closer to actual field deployment. The subsequent testing phase, planned for the second and third quarters of 2025, aims to validate the system in real-world agricultural settings. This period will be crucial for gathering data, assessing the system's performance, and making necessary adjustments before a full-scale launch.

The development of the ADPS stands as a testament to the collaborative spirit and commitment to innovation in addressing some of the most pressing challenges in agriculture. As the project moves closer to realization, it holds the promise of transforming agricultural practices by providing comprehensive, technologically advanced solutions for crop protection and environmental sustainability.

The inclusion of the provisional application by reference is to ensure continuity and to utilize the earlier filing date for the benefit of priority under 35 U.S.C. § 119 (e). This incorporation by reference does not constitute an admission that the referenced provisional application is prior art to the present invention.

All documents and publications mentioned in this application, including Provisional Application No. 63/495,100, and any patents, applications, and publications referenced therein, are hereby incorporated by reference in their entireties for all purposes.

### ENHANCED SUMMARY OF THE AGRICULTURE DETECTION PROTECTION SYSTEM (ADPS)

The Agriculture Detection Protection System (ADPS) is an innovative solution designed to transform agricultural management and the way agricultural fields are monitored and protected through advanced technology. Developed from its inception in 2016 at the University of Arizona, the ADPS integrates a range of technologies such as LIDAR, radar, cameras, and a fleet of multifunctional drones for comprehensive field surveillance and wildlife mitigation, with its beta testing phase planned for 2025.

At its core, the ADPS is an integrated system designed to offer comprehensive surveillance of agricultural fields, advanced crop health analysis, and effective wildlife mitigation. The system ingeniously combines several state-of-the-art technologies, including LIDAR for detailed topographical and vegetation mapping, radar for precise movement detection, high-definition cameras for round-the-clock monitoring, and an array of sound systems for wildlife deterrence.

A distinctive feature of the ADPS is its fleet of multifunctional drones, equipped with GPS, cameras, and various dispensing mechanisms. These drones are capable of deploying fluids, powders, and seeds for crop treatment and planting purposes, in addition to employing scent dispersal techniques as a humane wildlife deterrent. The integration of thermal imaging and pyrotechnics further enhances the system's capability to monitor and protect fields under diverse environmental conditions.

Powered by advanced AI algorithms, the ADPS not only detects potential threats from wildlife but also performs comprehensive crop health diagnostics. These diagnostics can identify early signs of disease, deficiencies, and pest infestation, enabling prompt and precise interventions for crop management.

A central processing unit orchestrates the operation of the entire system, utilizing real-time environmental data and wildlife behavior to make informed decisions. The operator can interact with the system through a user-friendly interface, which allows for monitoring, custom setting adjustments, and receiving real-time data and alerts.

The ADPS is characterized by its adaptability and responsiveness to environmental conditions, ensuring that the system's actions are both effective in protecting the agricultural environment and considerate of ecological balance. As such, the system aligns with sustainable agricultural practices, offering a solution that is as environmentally conscious as it is technologically advanced.

The ADPS is designed to address such disparities by reducing losses caused by wildlife, a key factor in lower crop yields. By effectively deterring wildlife and providing real-time monitoring and intervention, ADPS has the potential to significantly enhance agricultural productivity. For instance, in fields where wildlife intrusion has negatively impacted crop yield, the implementation of the ADPS could lead to a marked improvement in the output of both high and low-yielding areas.

Furthermore, the comprehensive approach of the ADPS, encompassing crop health analysis, targeted treatments via its multifunctional drones, and environmental adaptability, positions it as an essential tool in modern agricultural practices. By reducing the variance in crop yield across different areas of a field, the ADPS not only enhances overall productivity but also contributes to the sustainability and efficiency of agricultural operations.

In conclusion, the ADPS stands as an innovative solution to modern agricultural challenges, encapsulating the synergy of advanced technologies in a single, cohesive system. The Agriculture Detection Protection System stands as a testament to the power of integrating advanced technologies in agriculture. Its ability to mitigate wildlife threats, coupled with its crop monitoring and treatment capabilities, offers a promising solution to increase food production, ultimately leading to a more sustainable and productive agricultural future. Its anticipated field tests in 2025 are set to pave the way for a new era in agricultural management, offering unprecedented capabilities in field surveillance, crop health management, and wildlife mitigation.

### FIELD OF THE INVENTION

The present invention relates to the field of agricultural technology, with a particular focus on advanced solutions for field surveillance, crop health analysis, and wildlife mitigation. Specifically, the invention describes the Agriculture Detection Protection System (ADPS), a comprehensive system designed to monitor agricultural fields, analyze the health of crops through sophisticated technology, and effectively mitigate the intrusion of wildlife, thereby enhancing crop productivity and reducing losses due to wildlife interference.

Moreover, while the primary application of the ADPS is in the agricultural sector, its underlying principles and technologies have broader applicability. The system's advanced surveillance capabilities, which include the use of LIDAR, radar, high-definition cameras, drones equipped with various sensors and deterrent mechanisms, and AI-driven analysis, can be adapted for use in other areas requiring similar surveillance and deterrence strategies.

One such notable application is border surveillance, where the ADPS can be effectively utilized to monitor and secure borders. Its ability to detect, analyze, and respond to intrusions can be valuable in preventing illegal crossings, much in the same way it deters wildlife from entering protected agricultural areas. The system's versatility in detection, along with its non-invasive deterrent mechanisms, make it suitable for adapting to border security needs, ensuring thorough surveillance while respecting the safety and rights of individuals.

In summary, the ADPS stands as an innovative contribution to the field of agricultural technology, with potential applications extending into border security and surveillance. Its multifaceted approach, combining cutting-edge technology with environmental consideration, opens up avenues for its use in various fields requiring vigilant monitoring and responsive action.

1. An agricultural field management system, comprising: Radar, and camera-based sensors for detecting wildlife presence within a predetermined range of agricultural fields.

2. The system of claim 1, wherein: The drones are configured to automatically deploy upon wildlife detection, engaging deterrent protocols involving variable lights, sounds, and laser patterns.

3. The system of claim 1, wherein: Deterrent methods are adjusted in real-time based on monitored wildlife reactions, employing machine learning algorithms for efficacy optimization.

4. The system of claim 1, wherein: Drones include aromatherapy modules as an additional wildlife deterrent, activated based on specific wildlife species detected.

5. A method for managing agricultural fields utilizing the system of claim 1, comprising: Detecting potential wildlife threats via radar and camera sensors; Deploying drones towards detected threats, where the drones engage in wildlife deterrent actions; Analyzing wildlife response and modifying deterrent actions in real-time.

6. A method for escalating engagement in an agricultural field management system, according to the system of claim 1, comprising: Monitoring the movement and response of detected wildlife and escalating to additional deterrent phases based on proximity to the field and effectiveness of initial deterrent measures.

7. The system of claim 1, wherein: Weather and radar data are integrated as essential metadata to enhance decision-making for drone deployment and adjustment of deterrent strategies.

8. The system of claim 1, wherein: Each drone performs a pre-flight check protocol, including visual inspection, camera and laser functionality tests, and communication system verification.

9. A method of real-time field scanning and intervention using the system of claim 1, comprising: Assigning path planning and deployment for daily drone flights, executing field scans for crops and pests, and deploying interventions like pesticide spraying or weed control as necessary.

10. The system of claim 1, wherein: The drones are configured with variable engagement protocols specific to different wildlife species, including tailored light, sound, and laser patterns, as well as scent releases.

11. The system of claim 1, further comprising: An analytical component to assess the effectiveness of deterrent strategies over time, enabling continuous improvement and customization based on historical data.

12. The system of claim 1, wherein: The central processing unit is equipped to coordinate a fleet of drones, ensuring optimal coverage and response time for wildlife deterrent and crop monitoring actions.

13. A method for adaptive deterrent strategy in the system of claim 1, comprising: Implementing a learning algorithm that dynamically adjusts deterrent tactics based on the wildlife's previous responses to various deterrent methods.

14. The system of claim 1, wherein: Integration with a ground-based control station is included, providing real-time data visualization, system status updates, and manual control options for the operator.

15. The system of claim 1, further comprising: Drone-to-drone communication protocols that allow the aerial units to operate in a coordinated manner, avoiding collisions and optimizing engagement strategies.

16. The method of claim 7, further comprising: Employing a tiered response mechanism, where the intensity and nature of the engagement tactics escalate based on the proximity and size of the detected wildlife threat.

17. The system of claim 1, wherein: The drones are equipped with a self-diagnostic tool to regularly check their operational status, reporting any maintenance or repair needs to the central system.

18. A method for real-time environmental adaptation in the system of claim 1, comprising: Analyzing incoming weather data to adjust the flight paths and engagement strategies of the drones to maintain efficiency during adverse weather conditions.

19. The method of claim 7, further comprising tailoring detection, engagement, and deterrence strategies to specific wildlife behaviors and environmental conditions encountered in the agricultural fields.

20. An agricultural management system, characterized by its integrated coordination of various technologies and components functioning as a cohesive unit, the system comprising: radar and camera-based sensors for detecting wildlife presence within a predetermined range of agricultural fields; drones equipped with GPS, LiDAR, lights, sounds, and laser deterrent mechanisms; and a central processing unit for receiving data from said drones and sensors and coordinating the operation of said drones based on the received data.
